(19) United States
(12) Patent Application Publication
(10) Pub. No.: US 2003/0065420 A1
(43) Pub. Date: Apr. 3, 2003

(54) Part forming machine controller having integrated sensory and electronics and method thereof

(76) Inventors: Edward F. Kachnic, Douglasville, GA (US); Benjamin J. Pryhoda, Lafayette, CO (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/246,974

(22) Filed: Sep. 19, 2002

Related U.S. Application Data
(63) Continuation of application No. 09/644,389, filed on Aug. 23, 2000.
(60) Provisional application No. 60/212,518, filed on Jun. 19, 2000.

(51) Int. Cl. G06F 19/00

(52) U.S. Cl. 700/204; 700/108

(57) ABSTRACT

The present invention replaces the multiple controller systems by incorporating the controller of sensory devices with the part-forming machine controller (typically a personal computer), thereby producing a synergistic combination. More specifically, sensory devices such as, for exemplary purposes only, cameras, infrared sensors, ultrasonic sensors, or other sensing devices are connected directly to one or more preexisting serial, parallel or USB ports or other bus interfaces of the machine controller. By programming the machine controller or loading software therein, the machine controller can receive the input signal(s)/data from the sensory device, analyze the data, provide an output signal to the sensory device and communicate directly and contemporaneously with the machine controller software.

This application is a continuation of application number 09/644,389 filed on Aug. 23, 2000, which claims the benefit under 35 U.S.C. 119(e) of U.S. provisional application No. 60/212518, filed on Jun. 19, 2000.

### TECHNICAL FIELD

The present invention relates generally to part forming machines and more specifically to a part forming machine controller having integrated sensory and electronics. The present invention further relates to a method of forming parts and using integrated sensory to detect the presence, absence and quality of parts within a mold.

### BACKGROUND OF THE INVENTION

The parts forming industry is one of the world's largest industries in both total revenue and employment. As a multi-billion dollar industry, even small improvements to the manufacturing process can prove to have an enormous production efficiency and thus financial impact. Numerous methods and machines have been designed for forming parts. For instance, parts are generally formed via molds, dies and/or by thermal shaping, wherein the use of molds is presently the most widely utilized. There are many methods of forming a part via a mold, such as, for exemplary purposes only, stretch-blow molding, extrusion blow molding, injection blow molding, vacuum molding, rotary molding and injection molding.

One typical method of forming hollow containers is via a widely utilized process known as stretch blow-molding, wherein typically a three piece mold having two opposing side members and a bottom/push-up mold is utilized. Commonly, an injection molded preform, shaped generally like a test tube (also known as the parison), is inserted into the top of the mold. A rod is inserted inside the parison and is utilized to extend the parison to the bottom of the mold, upon which compressed air is forced into the parison, thus stretching the parison outward first toward the approximate center of the side mold members and then over and around the push-up/bottom mold. The parison is generally amorphous prior to initiating the blow process; however, after stretching the parison, the molecules align thereby forming a container having high tensile strength.

An even more popular method is the forming of parts utilizing a technique known as injection molding. Injection molding systems are typically used for molding plastic and some metal parts by forcing liquid or molten plastic materials or powdered metal in a plastic binder matrix into specially shaped cavities in molds where the plastic or plastic binder matrix is cooled and cured to make a solid part. For purposes of convenience, references herein to plastic and plastic injection molds are understood to also apply to powdered metal injection molding and other materials from which shaped parts are made by injection molding, even if they are not mentioned or described specifically.

A typical injection mold is made in two separable portions or mold halves that are configured to form a desired interior mold cavity or plurality of cavities when the two mold halves are mated or positioned together. Then, after liquid or molten plastic is injected into the mold to fill the interior mold cavity or cavities and allowed to cool or cure to harden into a hard plastic part or several parts, depending on the numbers of cavities, the two mold halves are separated to expose the hard plastic part or parts so that the part or parts can be removed from the interior mold cavity or cavities.

In many automated injection molding systems, ejector apparatus are provided to dislodge and push the hard plastic parts out of the mold cavities. A typical ejector apparatus includes one or more elongated ejector rods extending through a mold half into the cavity or cavities and an actuator connected to the rod or rods for sliding or stroking them longitudinally into the cavity or cavities to push the hard plastic part or parts out of the cavity or cavities. However, other kinds of ejector apparatus, such as robotic arms, scrapers, or other devices may also be used. Such ejectors are usually quite effective for dislodging and pushing hard plastic parts out of mold cavities, but they are not foolproof. It is not unusual for an occasional hard plastic part to stick or hang-up in a mold cavity in spite of an actuated ejector. One quite common technique is to design and set the ejectors to actuate or stroke multiple times in rapid succession, such as four or five cycles each time a hard plastic part is to be removed, so that if a part sticks or is not removed from a mold cavity the first time it is pushed by an ejector, perhaps it can be dislodged by one or more subsequent hits or pushes from the ejectors. Such multiple ejector cycles are often effective to dislodge and clear the hard molded plastic parts from the molds. Disadvantages of multiple ejector cycling, however, include the additional time required for the multiple ejector cycling each time the mold is opened to eject a hardened plastic part before it is closed for injection of a subsequent part and the additional wear and tear on the ejector equipment and the molds occasioned by such multiple cycling. Over the course of days, weeks, and months of injection molding parts in repetitive, high volume production line operations, such additional time, wear, and tear can be significant production quantity and cost factors.

On the other hand, stuck or incompletely ejected hard plastic parts can also cause substantial damage to molds and lost production time. In most injection mold production lines, the injection molding machines operate automatically, once the desired mold is installed, in continuous repetitive cycles of closing the mold halves together, heating them, injecting liquid or molten plastic into the mold cavities, cooling to cure or harden the plastic in the mold into hard plastic parts, opening or separating the mold halves, ejecting the molded hard plastic parts, and closing the mold halves together again to mold another part or set of parts. Very high injection pressures are required to inject the liquid or molten plastic into the mold cavities to completely fill all portions of the cavities in a timely manner, and such high pressures tend to push the mold halves apart during injection of the plastic. To prevent such separation of the mold halves during plastic injection, most injection molding machines have very powerful mechanical or hydraulic rams to push and hold the mold halves together. If a hard plastic part from the previous cycle is not ejected and completely removed from between the mold halves, the powerful mechanical or hydraulic rams will try to close the mold halves onto the hard plastic part, which can and often does damage one or both of the mold halves. Molds are usually machined very precisely from stainless steel or other hard metal, so they are very expensive to replace, and the down-time required to change them is also costly in labor and lost production. It is also not unusual for some of the plastic in a mold cavity to break apart from the rest of the part being molded in the cavity and remain in the mold cavity when the rest of the molded part is ejected. Such remaining material will prevent proper filling and molding of subsequent parts in the cavity, thus causing the subsequent molded parts to be defective. In automated production lines, substantial numbers of such defective parts can be produced before someone detects them and shuts down the injection molding machine for correction of the problem.

To avoid such mold damage, down-time, and defective molded parts as described above, various technologies have also been developed and used to sense or determine whether the hard molded plastic parts have indeed been dislodged and completely ejected or removed from the molds before the mechanical or hydraulic rams are allowed to close. Such technologies have included light beam sensors, vision systems, air pressure sensors, vacuum sensors, and others. U.S. Pat. No. 4,841,364 issued to Kosaka et al. is exemplary of a vision system in which video cameras connected to a vision system controller take video images of the open mold halves for computerized comparison to video images of the empty mold halves stored in memory to detect any unremoved plastic parts or residual plastic material in the mold halves. U.S. Pat. No. 4,236,181 issued to Shibata et al. is also an example of a vision system wherein photosensors are provided on a face plate of a CRT to electrically detect if a part has been removed.

U.S. Pat. No. 4,603,329 issued to Bangerter et al. shows an optoelectric sensor system coupled to a controller for sensing presence or absence of the molded plastic parts, while U.S. Pat. No. 3,303,537 issued to Mislan uses infrared sensors to detect heat from any plastic that may be retained in the mold. As an improvement to the above systems, U.S. Pat. No. 5,928,578 issued to Kachnic et al. provides a skip-eject system for an injection molding machine, wherein the system comprises an electronic camera for acquiring an actual image of an open mold after a part ejector has operated and a controller for comparing such actual image with an ideal image of the open mold to determine if the part still remains in the mold. If so, the controller outputs an ejector signal to actuate the ejector to cycle again. Additionally, the patents to Kachnic et al., Kosaka et al. and Shibata et al. provide a means for inspecting the part for defects.

All or at least most of the above detection systems provide some kind of interlock circuit connected or interfaced with the automatic cycling controls of automated injection molding machines to shut-down or otherwise prohibit the injection molding machines from closing the mold halves together if a plastic part or other material is still detected in one or both of the mold halves after the ejection portion of the molding cycle in order to avoid damage to the mold. As such, in each of the above systems, signals to and from the machine controller to ensure proper and timely automatic cycling is critical.

However, in view of the present system and method, the prior systems are disadvantageous. More specifically, the above systems require the use of separate controllers to receive input signals, provide data comparison and/or determine sensory parameters and then generates the proper output signal to the sensory device and/or to the molding machine controller. As an example, a sensory controller, such as a machine vision system, has sensory input, such as a camera image(s), which typically are analyzed two times per cycle. The first analysis typically is immediately after the mold open complete signal from the molding machine is given to the sensor system controller. The purpose is to verify the presence of parts in the moving side of the mold. If the analysis is affirmative, then it is concluded that parts have left the fixed side of the mold and are present on the moving side of the mold. The second analysis is typically after the molding machine has signaled to the sensory controller that the part ejection portion of the molding cycle is complete. Many times this includes several ejection strokes. The purpose is to verify the absence of parts in the moving side of the mold. If the analysis is affirmative, then it is concluded the moving side of the mold has parts removed. Signal inputs into the machine controller are typically digital outputs from the sensory controller. Signals from the machine controller are typically digital inputs into the sensory controller.

There are many variations to the above example, however all include a sensory controller, sensor input(s) to the sensor controller, analysis of the input data, and a digital input/output resultant scheme to the machine controller. This methodology duplicates the user interface and requires an independent CPU hardware system, digital input/output interface and associated cabling thereby substantially increasing the costs of the system. In addition, as more interfaces, CPUs and cabling are added to a data system, the system becomes inherently less reliable. Moreover, with prior systems, the machine controller polls data input/output from the sensor controller and then waits for the data. In extremely time sensitive automatic cycling systems such as injection molding machines, even slight delays can affect the overall efficiency of the system and result in substantial increase in the cost of goods.

Therefore, it is readily apparent that there is a need for a part-forming system that can reduce the added costs of having an independent sensor controller and reduce the data processing time of prior systems and thus, improve efficiency. It is, therefore, to the provision of such an improvement that the present invention is directed.

### SUMMARY OF THE INVENTION

According to its major aspects and broadly stated, the present invention is a part forming machine controller having integrated sensory and electronics, and a method of forming parts and using integrated sensory to detect the presence, absence and quality of parts within a mold.

The present invention replaces the multiple controller systems by incorporating the controller of sensory devices with the part-forming machine controller (typically a personal computer), thereby producing a synergistic combination. More specifically, sensory devices such as, for exemplary purposes only, cameras, infrared sensors, ultrasonic sensors, or other sensing devices are connected directly to one or more preexisting bus interfaces of the machine controller. By programming the machine controller or loading software therein, the machine controller can receive the input signal(s)/data from the sensory device, analyze the data, provide an output signal to the sensory device and communicate directly and contemporaneously with the machine controller software.

Thus, a feature and advantage of the present invention is to provide a new and improved integrated part-forming controller, wherein the integration of the sensor electronics into the machine controller eliminates the need for an external sensor controller, independent CPU hardware system, duplication of the user interface, digital input/output interfaces, associated cabling and connections. Inherently, this makes the molding system more reliable.

Another feature and advantage of the present invention is to provide a new and improved integrated part-forming controller, that eliminates the need for duplicating user interfaces, independent CPU hardware systems,

Another feature and advantage of the present invention is to provide a new and improved integrated part-forming controller, that eliminates sensory controllers and thus is inherently more reliable.

Another feature and advantage of the present invention is to provide a new and improved integrated part-forming machine controller, wherein the integration allows the molding machine controller to operate more efficiently by integrating the sensory processing with the entire molding process. The molding machine's controller requests inspection sensor data on demand, the resulting analysis is performed on the molding machine's controller's host CPU(s).

Another feature and advantage of the present invention is to provide a new and improved integrated part-forming machine controller, wherein there is no waiting for polling of digital input/output interface signals from the sensor controller, and thus, the continuation of the molding cycle is more efficient due to closer coupling of the analysis result and the molding process.

Another feature and advantage of the present invention is to provide a new and improved integrated part-forming machine controller, wherein ejection cycle time can be further improved by incorporating the Skip-Eject methods from U.S. Pat. No. 5,928,578. More specifically, after each ejection stroke, calls are made to process and analyze sensory data. If part ejection is confirmed, then further unnecessary ejector strokes are canceled or eliminated from the molding cycle. As such, as an integrated controller, delays between ejection cycles can be reduced.

Another feature and advantage of the present invention is to provide a new and improved integrated part-forming machine, wherein the integration also allows the machine controller to become a quality control inspection station, which detects measures, and sorts formed parts for quality defects. Parts can be inspected on the parting line surface in the mold or removed from the mold via a robotics type device and presented to one or more sensors. Quality data can be processed before or in parallel with the next molding cycle to determine pass or fail of the inspection criteria. Feedback to the molding process can be given to continue, adjust the process, or stop the molding process and wait for manual intervention. Part quality is verified and the overall part forming process is improved by reducing the number of defective parts produced.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a typical injection molding machine equipped with a vision detection system;

FIG. 2 is a partial cross-sectional side elevation view of the injection molding machine of FIG. 1 showing the ejectors retracted;

FIG. 3 is a partial cross-sectional side elevation view of the injection molding machine of FIG. 1 showing the ejectors extended;

FIG. 4 is a diagrammatic representation of the flow logic of a prior art system known as the skip-eject system;

FIG. 5 is a functional block diagram of a control of a prior art system known as the skip-eject system;

FIG. 6 is a functional block diagram of a typical prior art machine controller and sensory controller system; and

FIG. 7 is a functional block diagram of the integrated controller according to a preferred embodiment the present invention.

### DETAILED DESCRIPTION OF THE PREFERRED AND ALTERNATE EMBODIMENTS

In describing the preferred embodiment of the present invention illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

With regard to all such embodiments as may be herein described and contemplated, it will be appreciated that optional features, including, but not limited to, aesthetically pleasing coloration and surface design, and labeling and brand marking, may be provided in association with the present invention, all without departing from the scope of the invention.

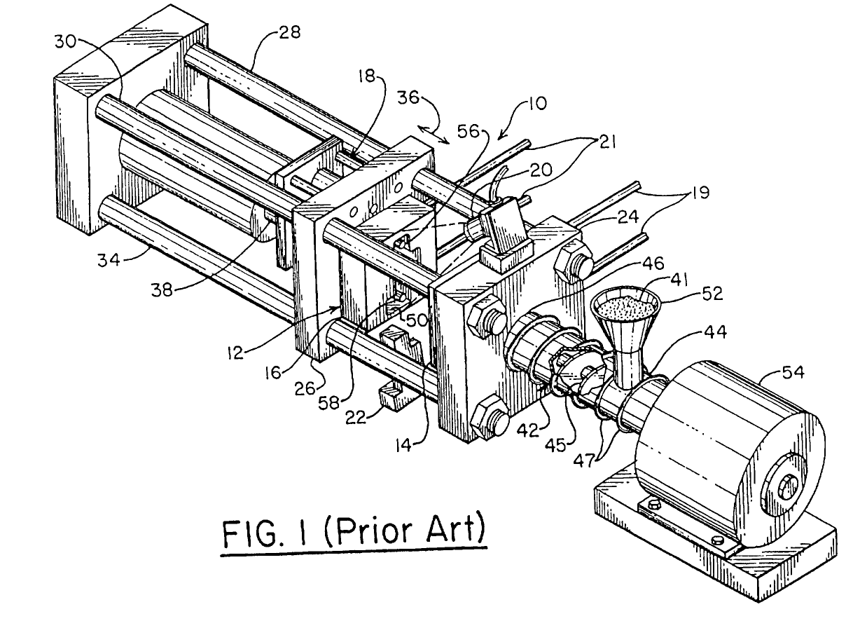

To better understand the present system and method of this invention, a rudimentary knowledge of a typical injection molding machine and process is helpful. Therefore, referring first to FIGS. 1-3, a typical, conventional automated injection molding machine 10 is shown equipped with a mold 12 comprising two mold halves 14, 16, a sliding rod-type ejector system 18, and a CCD (charge coupled device) array electronic camera 20 for acquiring visual images of the open mold half 16 in electronic pixel format that can be digitized, stored in memory, and processed to detect presence or absence of a plastic part or material in the mold half 16. It is important to understand, however, that present invention will also work just as well with any of the part or material sensor or detection systems or techniques mentioned above as well as many others; therefore, while the system and method of the present invention is described conveniently with the typical, conventional injection molding apparatus described herein, it is not limited to application or implementation with only such conventional apparatus.

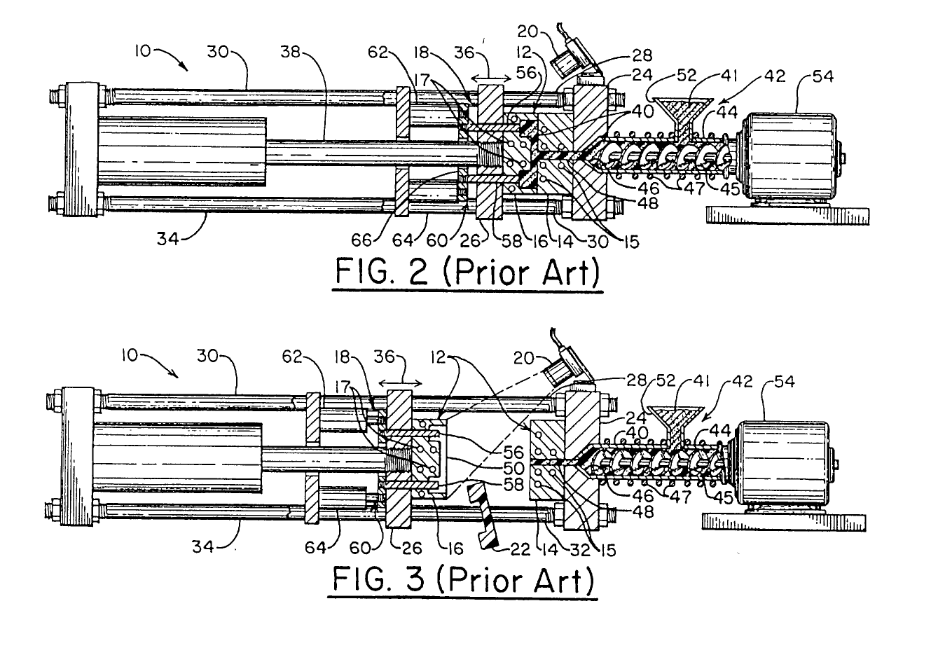

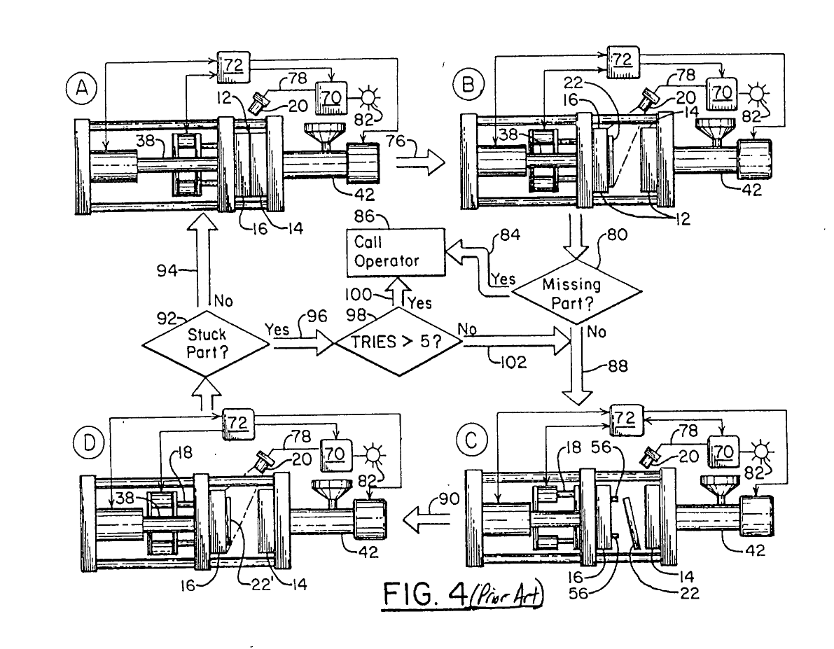

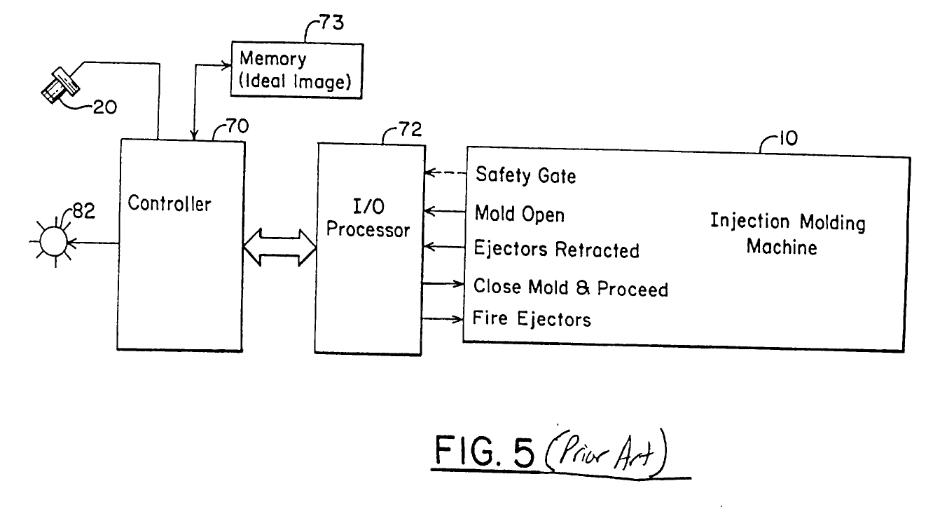

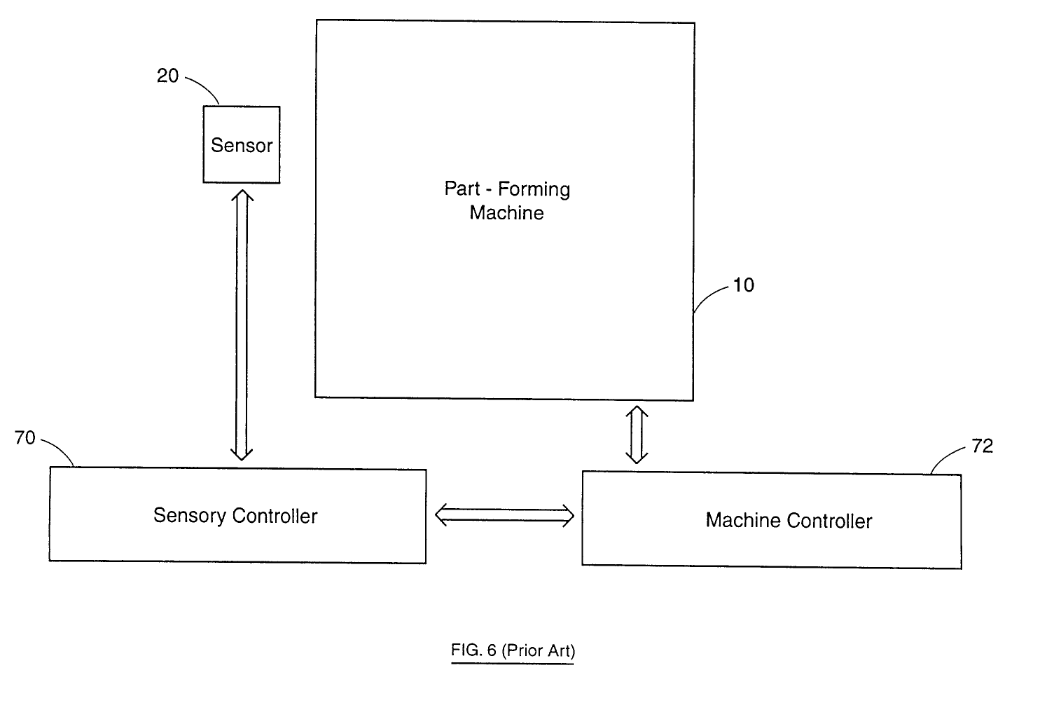

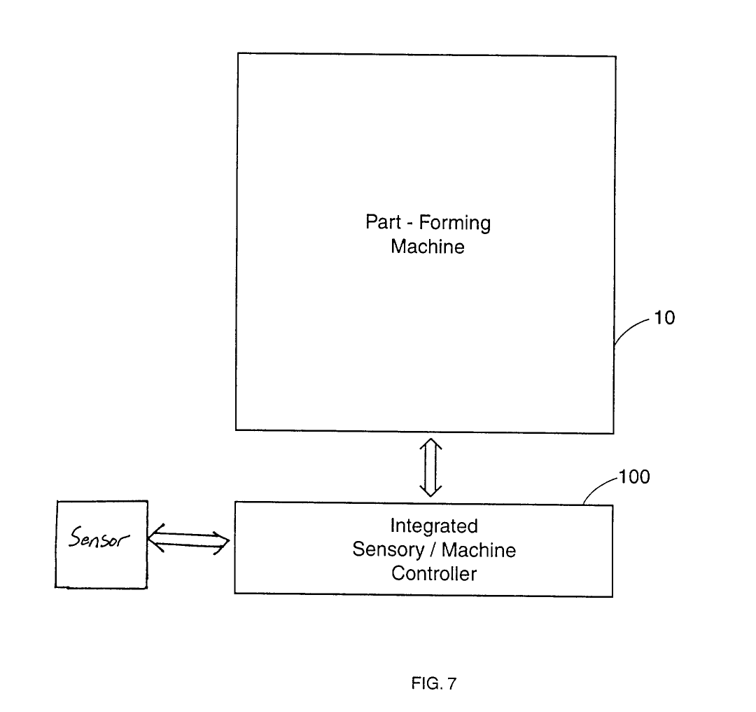

In general, the exemplary conventional injection molding machine 10 comprises two platens 24, 26 mounted on a frame made of four elongated, quite substantial frame rods 28, 30, 32, 34 for mounting the two halves 14, 16 of mold 12. The stationary platen 24 is immovably attached to rods 28, 30, 32, 34, while the moveable platen 26 is slidably mounted on the rods 28, 30, 32, 34 so that it can be moved back and forth, as indicated by arrow 36, in relation to the stationary platen 24. Therefore, the mold half 16 mounted on moveable platen 26 is also moveable as indicated by arrow 36 in relation to the other mold half 14 that is mounted on stationary platen 24. A large hydraulic or mechanical ram 38, which is capable of exerting a substantial axial force, is connected to the moveable platen 26 for moving the mold half 16 into contact with mold half 14 and holding them together very tightly while liquid or molten plastic 40 is injected into mold 12, as best seen in FIG. 2. Most molds 12 also include internal ducts 15, 17 for circulating heating and cooling fluid, such as hot and cold water, through the respective mold halves 14, 16. Cooling fluid supply hoses 19, 21, as shown in FIG. 1, connect the respective ducts 15, 17 to fluid source and pumping systems (not shown). Hot fluid is usually circulated through ducts 15, 17 to keep the mold 12 hot during the injection of liquid or molten plastic 40 into cavity 50. Then cold fluid is circulated through ducts 15, 17 to cool the mold 12 to allow the liquid or molten plastic 40 to solidify into the hard plastic part 22 that is shown in FIG. 3. A typical plastic injector or extrusion system 42 may comprise an injector tube 44 with an auger 45 in the tube 44 for forcing the liquid or molten plastic 40 through an aperture 46 in the stationary platen 24 and through a duct 48 in mold half 14 into a mold cavity 50 that is machined or otherwise formed in mold half 16. In many applications, there are more cavities than one in the mold 12 for molding cycle. In such multiple cavity molds, multiple ejectors may be required to eject the hard molded parts from all of the cavities. The plastic extrusion system 42 also includes a hopper or funnel 52 for filling the tube 44 with the granular solid plastic 41, a heating coil 47 or other heating system disposed around the tube 44 for heating the granular plastic 41 enough to melt it in the tube 44 to liquid or molten plastic 40, and a motor 54 for driving the auger 46.

As illustrated in FIG. 2, after the liquid or molten plastic 40 is injected into the mold 12 to fill the mold cavity 50, and after the plastic 40 in the mold cavity has solidified as described above, the ram 38 is actuated to pull the mold half 16 away from the mold half 14 so that the hard plastic part 22 can be ejected from mold cavity 50. Ejection of the hard plastic part 22, as mentioned above, can be accomplished by a variety of mechanisms or processes that can be made more efficient and effective by this invention, and the ejector system 18 illustrated in FIGS. 1-3 is but one example that is convenient for describing this invention. The ejector system 18 includes two slidable ejector rods 56, 58 that extend through the moveable platen 26 and through mold half 16 into mold cavity 50. When the mold 12 is closed for filling the mold cavity 50 with plastic 40, as shown in FIG. 2, the ejector rods 56, 58 extend to, but not into the mold cavity. However, when the mold 12 is opened, as shown in FIG. 3, an ejector actuator 60, which comprises two small hydraulic cylinders 62, 66 and a cross bar 68 connected to the ejector rods 56, 58, pushes the ejector rods 56, 58 into the mold cavity 50 to hit and dislodge the hard plastic part 22 and push it out of the cavity 50. Because one hit or push by the ejector rods 56, 58 is occasionally not enough to dislodge and push the hard plastic part 22 all the way out of the cavity 50, it is a common practice to cycle the ejector actuator 60 several times to cause the ejector rods 56, 58 to reciprocate into and out of the cavity 50 repetitively so that, if the hard plastic part 22 is still in the cavity, it will get hit and pushed several times, thus reducing instances when the hard plastic part 22 does not get completely ejected to a minimum. The machine controller 72, subsequently generates a data signal to the camera controller 70, as shown in FIG. 4, that the ejector rods 56, 58 have been actuated. Then the electronic camera 20, which is focused on the mold half 16, acquires an image of the mold half 16, including the cavity 50, and sends the image in electronic form to the camera controller 70, where it is digitized and compared to an ideal image of the mold half 16 and empty mold cavity 50. If the image comparison shows that the mold cavity 50 is empty and that the hard plastic part 22 has been cleared from the mold half 16, the camera controller 70 sends a data signal to the machine controller 72 to actuate the ram 38 to close the mold 12 to start a new molding cycle. On the other hand, if the image comparison shows that the hard plastic part 22 has not been dislodged from the cavity 50 or cleared from the mold half 16, the camera controller 70 sends a data signal to the machine controller 72 that the ram 38 is not allowed to close the mold 12, and a signal is generated via the machine controller 72 or the camera controller 70 to notify an operator to check the mold, clear any residual plastic or the hard plastic part 22 from the cavity 50 and mold 12, and then restart the plastic injection molding machine 10.

In the first state A illustrated in FIG. 4, the camera controller 70 sends a mold close signal to the machine controller 72, which in turn sends a mold close signal. In response, a close/open mechanism that includes a ram actuator actuates the ram 38 to close and press mold half 16 against the mold half 14 and followed by actuation of the plastic extrude system 42 to inject liquid or molten plastic into the mold 12 to form a plastic part. After allowing sufficient time for the plastic to harden, the process advances as indicated by arrow 76 to state B in which the ram 38 is actuated to pull mold half 16 away from mold half 14. When the mold 12 is open as illustrated in state B, an image of the open mold half 16 is acquired by electronic camera 20 and transmitted via electrical cable 78 to the camera controller 70, which digitizes and compares the image to an ideal image of the mold half 16 as it should appear with a properly formed plastic part 22 in the cavity. This comparison function of camera controller 70 is indicated in FIG. 4 by decision block 80. At this point in the sequence, there should be a fully formed hard plastic part 22 in mold half 16. Therefore, if the comparison at decision block 80 indicates that no plastic part 22 is present in mold half 16 or that plastic part 22 is present but incompletely formed, the camera controller 70 stops the sequence and generates a signal to an alarm 82, the machine controller 72 or other device as indicated by arrow 84, to signal an operator 86 to come and check the injection molding machine 10. However, if the comparison indicates that a fully formed plastic part 22 is present in the mold 12, as it is supposed to be, the camera controller 70 causes the sequence to continue, as indicated by arrow 88, to state C by sending a signal to the machine controller 72 which sends a signal to the injection molding machine 10 to actuate the ejector system 18 to extend the ejector rods 56, 58 to cycle once to hit or push the hard plastic part out of the mold half 16. However, as discussed above, occasionally, one extension of ejector rods 56, 58 will not dislodge or clear the hard plastic part 22 from mold half 16. Therefore, the camera controller 70 causes the sequence to proceed as indicated by arrow 90 to state D.

In state D, the camera controller 70 acquires another image of the mold half 16 in electrical form from electronic camera 20 via cable 78 and compares it, as indicated by decision block 92, to an ideal image, which is stored in memory, of the mold half 16 with the hard plastic part 22 removed and the mold cavity 50 (not seen in FIG. 4) empty. If the comparison at decision block 92 indicates that the part 22 is cleared and the cavity 50 is empty, the camera controller 70 continues the sequence as indicated by arrow 94 back to state A by sending a signal to the machine controller 72 which processes the data and then sends a signal the injection molding machine 10 to actuate the ram 38 to again close the mold 12 and to actuate the extruder system 42 to again fill the mold 12 with plastic. On the other hand, if the comparison at decision block 92 indicates the part 22 is stuck in the mold half 16 as indicated by phantom lines 22′ or otherwise not cleared, then the camera controller 70 proceeds as indicated by arrow 96 to check the number of times that the ejector rods 56, 58 have been extended or cycled. If, as indicated at decision block 98, the ejector rods 56, 58 have been cycled more than some reasonable number, such as three (3) or as previously set by the operator, in unsuccessful tries to dislodge and clear the part 22 from the mold half 16, the camera controller 70 sends a signal to the machine controller 72 which sends a signal to stop the sequence, and, as indicated by arrow 100, proceeds to signal the alarm 82 or other device 86 to call the operator. However, if the number of tries has not exceeded the number, such as five (5), the camera controller 70 returns the sequence to state C, as indicated by arrow 102, by signaling the machine controller 72 to again fire or cycle the ejector rods 56, 58 to hit or push the part 22 once again. The camera controller 70 then continues the sequence again as indicated by arrow 90 to state D where another image of the mold half 16 is acquired with camera 20 and compared again at 92 to the ideal image of how the mold half 16 should appear with the part cleared. If the part 22 was successfully cleared by the last extension or cycle of the ejector pins 56, 58, the sequence proceeds as indicated by arrow 94 to state A. However, if the comparison at 92 indicates the part 22′ is still stuck or not cleared, the camera controller 70 checks the number of tries at 98 and, if not more than the number, e.g., three (3), returns the sequence to state C again. The maximum number of tries set in decision 98 can be any number, but it is preferably set at a number, for example three (3), that is deemed to allow enough cycles or extensions of ejector rods 56, 58 to reasonably be expected to dislodge and clear the part 22 without becoming practically futile. Thus, multiple cycles of extensions and retractions of the ejector rods 56, 58 are available and used when the part 22 gets stuck, but unneeded repetitive cycles of the ejector rods 56, 58 are prevented when the part 22 has been dislodged and cleared from the mold.

By checking for a cleared mold half 16 with an empty cavity after every cycle or firing of the ejector system 18, rather than after every several firings, it is expected that the ejector system 18 will rarely have to be actuated or fired more than once in a part molding cycle, thus saving both time and wear. In production lines where an injection molding machine 10 is automatically cycled to continue producing plastic parts for weeks and months on end, the saved time can be significant and can allow each injection molding machine 10 to produce many additional parts in a year. For example, if all the hard plastic parts get ejected by the first ejector stroke in nine out of ten molding cycles, and if the hard plastic parts are always ejected after five ejector strokes, then variable ejector cycling according to this invention could save at least thirty-six strokes when compared to ten fixed stroke cycles. Specifically, fifty strokes (10 cycles×5 strokes/cycle) minus fourteen strokes (9 single strokes plus 1×5 strokes) equals thirty-six skipped ejector strokes.

As one can see from the above description, the overall injection molding process is extremely time sensitive. The present invention improves on this time sensitive and critical process by providing an integrated controller 100 that serves as both the sensor controller 70 and the machine controller 72. The integrated controller 100 is preferably a personal computer having serial, parallel and or USB ports for connecting data inputs. Known machine controller 72 programs are loaded into the integrated controller 100. One or more sensory devices 20 are connected directly to one or more preexisting serial, parallel or USB ports of the integrated controller 100. It should also be noted that data cards specific for the respective sensor 20 and having a interface port therein can be connected directly to the bus of the CPU of the computer to provide a connection means for the sensor 20. By programming the integrated controller 100 or loading known software therein, the integrated controller 100 can receive the input signal(s)/data from the sensory devices 20, analyze the data, provide an output signal to the sensory devices 20 and communicate directly and contemporaneously with the preexisting machine controller 72 software. The above-described processes performed by the sensor controller 70 and the machine controller 72 can all now be performed by the integrated controller 100.

It should be noted that one skilled in the art with knowledge of the parameters and the desired result can program the integrated controller 100 to analyze data and provide the appropriate signals to control the machine 10.

Although the preferred embodiment of the present invention is described herein utilizing a camera sensor, any known sensory device such as, for exemplary purposes only, infrared sensors, ultrasonic sensors, or any other known sensing devices may be utilized.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An integrated controller for use with a part-forming machine and a sensory device, comprising:
a computer having at least one data interface;
a program for controlling the part-forming machine; and
a program for analyzing data from the sensory device and for communicating with said part-forming machine program, wherein the sensory device is functionally communicatable with said at least one data interface of said computer, and wherein the part-forming machine is functionally communicatable with said at least one data interface of said computer.

2. The integrated controller of claim 1, further comprising means for displaying information, said display means being in communication with said computer.

3. The integrated controller of claim 1, wherein said at least one data interface of said computer is a bus.

4. The integrated controller of claim 1, wherein said at least one data interface of said computer is a USB port.

5. The integrated controller of claim 1, wherein said at least one data interface of said computer is a serial port.

6. The integrated controller of claim 1, wherein said at least one data interface of said computer is a parallel port.

7. The integrated controller of claim 1, wherein said computer has a first data interface and a second data interface, wherein the sensory device is functionally communicatable with said first data interface of said computer, and wherein the part-forming machine is functionally communicatable with said second data interface of said computer.

8. An integrated controller for use with an injection-molding machine and a sensory device, comprising:
a computer having a data interface;
a program for analyzing data from the sensory device and controlling the injection-molding machine and the sensory device in response to the sensory device data; and
means for displaying information, said display means being in communication with said computer, wherein the sensory device is functionally communicatable with said data interface of said computer, and wherein the injection-molding machine is functionally communicatable with said data interface of said computer.

9. The integrated controller of claim 8, wherein said data interface of said computer is a bus.

10. The integrated controller of claim 8, wherein said data interface of said computer is a USB port.

11. The integrated controller of claim 8, wherein said data interface of said computer is a serial port.

12. The integrated controller of claim 8, wherein said data interface of said computer is a parallel port.

13. The integrated controller of claim 8, wherein said computer has a first data interface and a second data interface, wherein the sensory device is functionally communicatable with said first data interface of said computer, and wherein the part-forming machine is functionally communicatable with said second data interface of said computer.

14. The integrated controller of claim 8, wherein said display device is a monitor.

15. The integrated controller of claim 8, wherein said display device is a printer.

16. An integrated controller for use with an part-forming machine, comprising:
a computer having a data interface;
a sensory device in communication with said data interface of said computer, said sensory device outputting sensory data to said computer via said data interface;
a program for analyzing said sensory data from said sensory device and controlling the part-forming machine and said sensory device in response to said sensory data; and
means for displaying information, said display means in communication with said computer, wherein said sensory device functionally communicates with said data interface of said computer, and wherein the injection-molding machine is functionally communicatable with said data interface of said computer.

17. The integrated controller of claim 16, wherein said sensory device is at least one vision sensor.

18. The integrated controller of claim 16, wherein said sensory device is at least one infrared sensor.

19. The integrated controller of claim 16, wherein said sensory device is at least one air pressure sensor.

20. The integrated controller of claim 16, wherein said sensory device is at least one vacuum sensor.

21. The integrated controller of claim 16, wherein said sensory device is at least one ultrasonic sensor.

22. The integrated controller of claim 16, wherein said display device is a monitor.

23. The integrated controller of claim 16, wherein said display device is a printer.

24. The method of controlling a part-forming machine, comprising the steps of:
a. using a sensory device to collect data regarding the condition of the part-forming machine;
b. communicating said data with a computer having a program to analyze said data and to generate data commands for controlling the part-forming machine; and
c. communicating said data commands to the part-forming machine.
